(19) United States
(12) Patent Application Publication
(10) Pub. No.: US 2007/0294319 A1
(43) Pub. Date: Dec. 20, 2007

(54) Method and apparatus for processing a database replica

(75) Inventors: Udgith A. Mankad, Shrewsbury, MA (US); Christophe A.D. Balczunas, Woonsocket, RI (US)

Correspondence Address: EMC Corporation;c/o WOLF, GREENFIELD & SACKS, P.C., 600 ATLANTIC AVENUE, BOSTON, MA, 02210-2206, US

(73) Assignee: EMC Corporation, Hopkinton, MA (US)

(21) Appl. No.: 11/449,163

(22) Filed: Jun. 8, 2006

(51) Int. Cl. G06F 17/30

(52) U.S. Cl. 707/204

(57) ABSTRACT

A computer system for mounting a replica of a database. The computer system includes a first instance of a database operating in a first environment. The first instance has allocated to it a first amount of a resource. A replica of this first instance is created and a second instance of the database is created from this replica. The second instance is created in a second environment and has allocated to it a second amount of the resource. The second amount of the resource is different from the first amount of the resource.

### FIELD OF THE INVENTION

The invention relates to techniques for processing a replica of a database.

### DESCRIPTION OF THE RELATED ART

Computer applications are widely used in business settings and frequently are implemented in a computing environment that includes a storage system capable of holding a large amount of data. As users access the application to perform transactions, data in the storage system is updated. For example, an enterprise may track all of its sales transactions with a database application that stores and updates data on the storage system. Such a database that is actively in use for processing transactions within an enterprise is called a production database. For an enterprise, it is often desirable that its production database be reliably and continuously available.

To ensure that a production database is reliably and continuously available, a system administrator may create a “replica” of the database. The replica captures the state of the production database at an instant in time. The system administrator may use the replica in any of multiple ways. One example is to create a backup copy of the production database, which may increase the reliability of the overall system by allowing the data to be recovered if a system failure should render the database unusable.

The backup copy can be made from a replica mounted on different computer resources than the production environment. An advantage of creating a backup copy of the database from such a replica rather than directly from the production database is that operation of the application is not suspended or degraded if network bandwidth and computer resources are used to transfer data from the storage system to a backup device.

Database replicas also may be used in other contexts in which accessing data in the production environment could interfere with operation of the application. For example, reports may be generated from the replica rather than from the production database.

Replicas may be created by a replication manager. A replication manager may create the replica by leveraging features provided by one or more storage systems on which the production database is stored. Under control of the replication manager, the storage system may create an image of the database, which is a copy of the objects in the storage system that belong to the production database. The image, together with other information that specifies how to recreate the state of the database application, constitutes the replica.

To use the replica, it is mounted in a computing environment, which may be an environment separate from the production environment in which the application operates while processing transactions within the enterprise. Thus, the mount environment may include a mount server that is separate from the production server. To use the replica, it is first “mounted” on the mount server. As part of mounting the replica, an instance of the database application is created on the mount server.

### BRIEF DESCRIPTION OF THE DRAWINGS

In the drawings, each identical or nearly identical component that is illustrated in various figures is represented by a like numeral. For purposes of clarity, not every component may be labeled in every drawing. In the drawings:

FIG. 1 is a diagram of a computer system executing a database application according to an embodiment of the invention;

FIG. 2 is a diagram of a production environment according to an embodiment of the invention;

FIG. 3 is a diagram of a prior art database replica;

FIG. 4 is a diagram of a mount environment according to an embodiment of the invention;

FIG. 5 is a diagram of a mount environment according to an alternative embodiment of the invention;

FIG. 6 is a diagram of an embodiment of an override file 470 as shown in FIG.4;

FIG. 7 is a diagram of an alternative embodiment of an override file 470 as shown in FIG. 4; and

FIG. 8 is a flow chart of a process of mounting a replica according to an embodiment of the invention.

### DETAILED DESCRIPTION

When mounting a replica, the mount environment is usually configured to duplicate the production environment. For example, an instance of a database application program in the mount environment is usually configured the same as a production application instance of the database program. This configuration increases the likelihood that the replica will operate in the mount environment the same way that the production database operates in the production environment.

The inventors have appreciated that conventional techniques for mounting a replica of a database in a mount environment that is identical to the production environment have some limitations. For example, it may be desirable to mount the replica in a mount environment configured differently than the production environment. In some embodiments, the replica will be mounted in an environment with less resources (e.g. memory, CPU cycles) allocated to it than are allocated to the production environment in which the replica was created. Because there is a cost associated with having resources available on a mount server, if a replica can be mounted with fewer resources, the cost the of computer system used to implement a mount environment can be decreased. Alternatively, reducing the resources allocated to mount a replica without reducing the total amount of resources available on the mount server allows the mount server to be used for more functions. For example, when fewer resources are allocated to each replica, a mount server may host multiple replicas simultaneously.

One embodiment of the invention relates to a method of creating a replica of a first instance of a database that is operating in a computing environment. A second instance of the database is then established from the replica in a second environment, but with the second instance having allocated to it resources that are not identical to those allocated to the first instance from which the replica was created.

Another embodiment relates to automating the mounting of a replica with a different configuration than the database in the production environment. The mount environment may be created in part from information in the replica, so some characteristics of the mount environment will be the same as in the production environment. However, other characteristics may be set based on information from other sources so that other characteristics of the mount environment differ from the characteristics of the production environment.

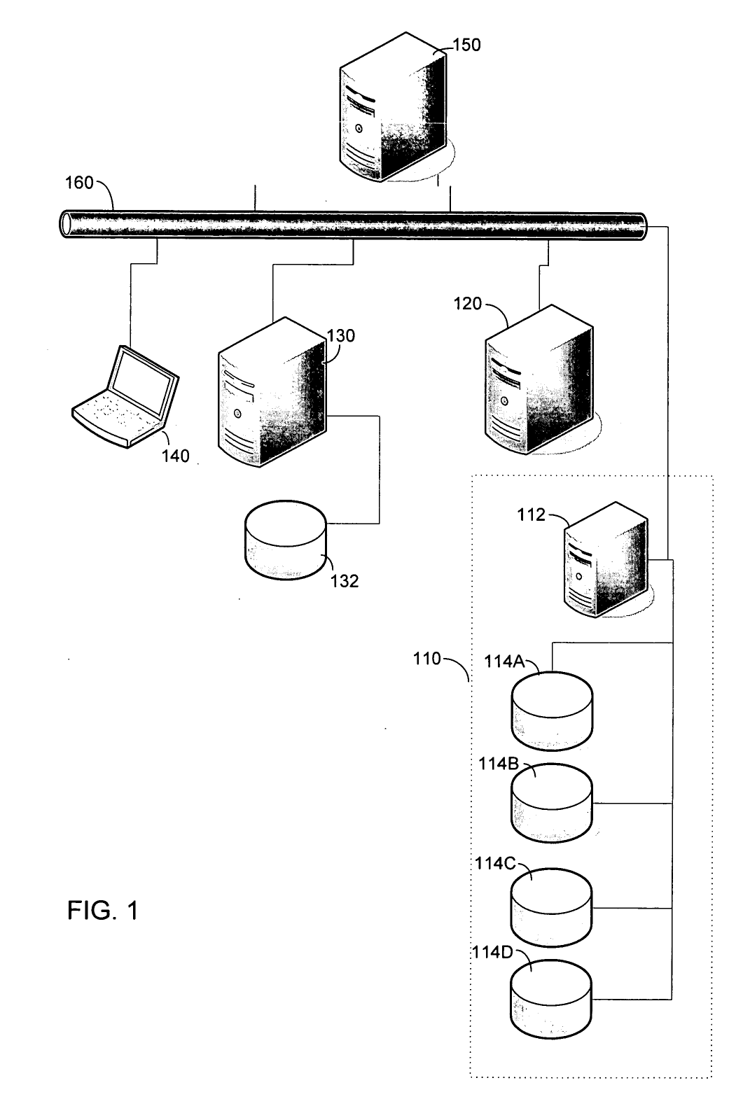

FIG. 1 illustrates an example of a computing system on which a replica may be created and/or mounted. FIG. 1 is just one example of the type of computer systems in which the invention may be employed, and the invention may be used in conjunction with any suitable computer system.

The computer system of FIG. 1 includes multiple interconnected computer devices, shown as storage system 110, production host 120, replication server 130, client 140 and mount host 150. In this embodiment, the devices are interconnected through a network 160. Network 160 may be an Ethernet network or any other type of network, whether now known or hereafter developed. In some embodiments, the computer system may span an enterprise having facilities in multiple geographic locations. Accordingly, network 160 may contain multiple subnets interconnected through a wide area network. However, the type of network used is not a limitation on the invention and the computer system may include any suitable network or networks.

Storage system 110, for example, may be from the line of SYMMETRIX® or CLARIION® storage systems sold by EMC Corporation of Hopkinton, Mass. However, any other suitable storage system may be used because the aspects of the invention described herein are not limited to use with any particular type of storage system.

Storage system 110 includes physical storage media, such as multiple physical disk drives (not expressly shown). Each disk drive may be capable of storing a large amount of data (e.g. Gigabytes of data). The type of storage media, the number of physical disk drives and the amount of data stored in each physical disk drives is not a limitation on the invention because any suitable storage system may be used, including storage systems that employ a simple disk drive or other type of storage medium.

Storage system 110 may make storage resources available to a host computer for assignment to entities therein, such as a file system, database manager or logical volume manager. If the storage system is a so-called “dumb” storage device, the storage resources made available to the computer will correspond in a one-to-one relationship to physical storage devices within the storage system. However, when the storage system is an intelligent storage system, it will present logical volumes of storage to the host computer that need not necessarily correspond in a one-to-one relationship to any physical devices with the storage system, because the intelligent storage system may map each logical volume of storage presented to the host across one or more physical storage devices.

In the example of FIG. 1, storage system 110 is an intelligent storage system. Controller 112 implements a mapping between logical volumes and physical locations. Consequently, storage system 110 may be considered to contain data stored in one or more logical volumes, of which logical volumes 114A, 114B, 114C and 114D are shown in FIG. 1. Some or all of these logical volumes may be used to store data associated with an application, such as a database.

One or more levels of mapping may be used to associate components of a database to information stored within a specific logical volume within storage system 110. For example, database components, such as data tables, may be associated with files and files may in turn be associated with specific logical volumes.

The foregoing is only one example of possible mappings between components used by an application and logical volumes as maintained in a storage system. Computer systems exist that have more or fewer levels of mapping. The aspects of the present invention can be used on systems having any number and configuration of mapping layers because the invention is not limited in this respect.

Production host 120 runs an application that accesses the data in storage system 110. For example, production host 120 may run a database application (e.g. those available from ORACLE® or SAP®) that maintains data on transactions undertaken within an enterprise. However, the invention is not limited to use in conjunction with programs conventionally known as “database” applications and may be used in conjunction with databases stored or maintained by any program, regardless of how it is classified. The invention is not limited by the specific application that manipulates data within storage system 110 and may be employed with any suitable application.

Production host 120 may be a conventional server, whether now known or hereafter developed. For example, a server, such as a SOLARIS®, HP®, Linux or AIX® server may be used. However, any suitable hardware may be used to implement production host 120. In many embodiments, production host 120 will interface with many users throughout an enterprise and process numerous transactions. Accordingly, production host 130 may be a server having a large amount of resources (e.g. memory and processing capability). However, the specific hardware used to implement production host 120 is not a limitation on the invention because the aspects of the invention described herein can be used with any type of hardware.

An instance of one or more applications performing various functions executes on production host 120 and is referred to herein as a “production instance.” The production instance may be a database application or other application that stores and retrieves production data within storage system 110.

Storage system 110 may use a portion of its logical volumes 114A, 114B, 114C and 114D to hold a primary version of the production data. Storage system 110 may use another portion of its logical volumes 114A, 114B, 114C and 114D to store a copy of the production data. Many storage systems, such as servers in the SYMMETRIX and CLARIION lines of storage systems made by EMC Corporation of Hopkinton, Mass., allow a user to configure the logical volumes in the storage system to designate some logical volumes for storing production data and some for storing a copy of that production data. The volumes storing the production data are sometimes called the “STD volumes,” and those storing the copy are sometimes called “Business Continuity Volumes” or “BCV.”

The storage system may be controlled to make a copy of the production data onto the BCV. Such a copy is sometimes called an “image” of the production data. The image may be made in response to a specific command or may be made in whole or in part dynamically as the production data is changed.

Creating a replica may involve a user, such as a system administrator, issuing commands to storage system 110 and the application instance of the application (e.g. a database application) to cause them to store information that describes the state of the computer system. The computer system of FIG. 1 includes replication server 130 that acts as a controller. Replication server 130 may be any suitable hardware device programmed to aid a user to issue the desired commands. An example of suitable software to control replication server 130 is replication management software provided by EMC Corporation of Hopkinton, Mass., although the invention is not limited to this example. The software can run on any suitable server or any other computer (including, for example, production host 120 or mount host 150). However, any suitable hardware or software may be used because the invention is not limited to any particular system configuration or any particular type of controller to manage the creation of a replica.

The replication software may present an interface to a system administrator or other user. The interface may be presented on a client computer, such as client 140 or any other computer in the system. Through that interface, the user may specify parameters of the replica to be created, including the data for which a replica is to be created. The replication software can then interact with the application to identify information include in the replica.

When portions of the replication software are located on a separate computer, the replication software may include an agent that is installed on production host 120 and interacts with the application instance. The replication software may issue appropriate commands to the application instance and to the storage system to create the replica in a manner described below.

To create a replica, the storage system ensures that the image represents a copy of the production data at a specific instance in time and does not change it after that. As the image is being created, the application instance may continue to interact with users changing the production data. As discussed below, these changes may be captured in a log file, which may constitute a portion of the replica because this information can be used to recreate the state of the application instance as it existed at the end of the process of creating a replica.

Information about the replica may be stored in a solid database 132 associated with replication server 130 or in any other suitable location. While the copy of the production data may be maintained on the volumes within storage system 110 designated as BCV, information, such as the identity of the BCV, may be stored within solid database 132. In addition, information that can be used to duplicate the application instance also can be stored as part of the replica.

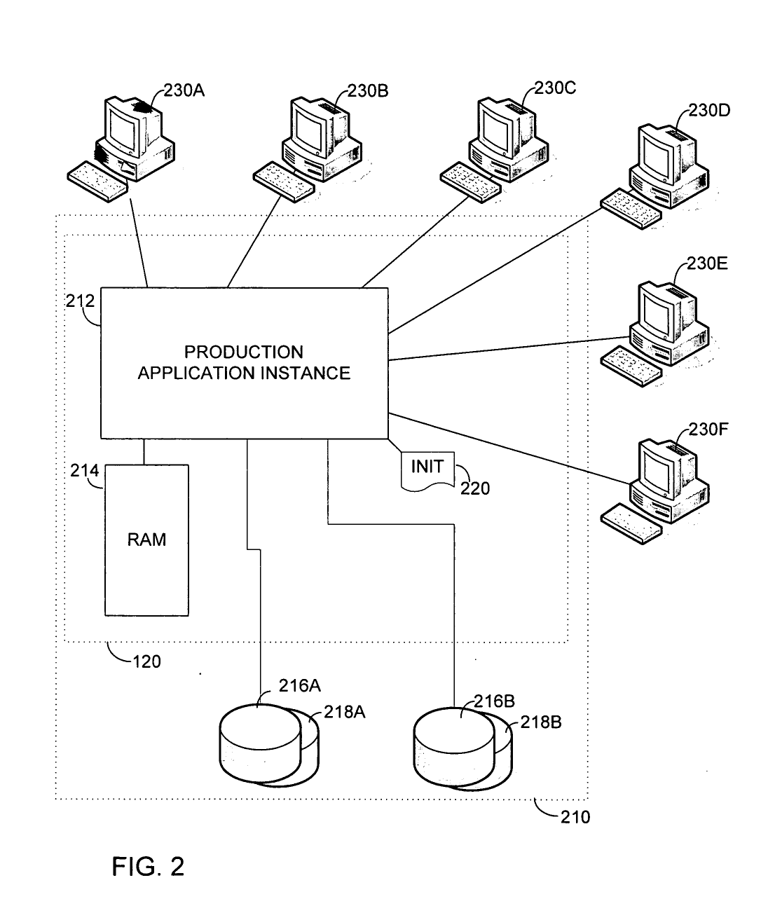

To illustrate the types of information that may be included in a replica in some embodiments, FIG. 2 shows schematically a production environment 210 in which an application may operate in the computer system of FIG. 1. Production environment 210 includes an instance 212 of an application program. As mentioned above, the application program may be a database application program or any other suitable application program.

In the illustrated embodiment, instance 212 may be an instance of a database program executing on a suitable platform, such as production host 120 (FIG. 1). Regardless of the specific platform used to implement production host 120, instance 212 is allocated resources on that platform. One example of the type of resources that may be used by an instance of an application program is computer memory (illustrated as RAM 214 in FIG. 2) allocated to instance 212. However, the types of resources used by an instance are not limited to RAM or computer memory in general, as other types of resources may be used by an instance of an application, depending on the application and the platform on which it executes. Other examples of resources include CPU cycles and network bandwidth.

Any suitable method may be used to specify the amount of resources allocated to an instance. In the embodiment pictured in FIG. 2, resources are allocated to production application instance 212 when the instance is initialized.

The amount of resources that are allocated to an instance may be specified in any suitable way. For example, an application may have a set of parameters associated with it. Values for these parameters may specify the amount of resources allocated to an instance. In the embodiment pictured in FIG. 2, values for a set of parameters to be used to create an instance may be stored in initialization file 220. For example, an ORACLE® database may have a file called INIT<ORACLE_SID>.ora associated with it to hold values of its initialization parameters. As part of initialization of application instance 212, those values may be read from initialization file 220 and used to allocate resources or otherwise set operating characteristics of the instance.

In operation, multiple users may interact with production application instance 212. To depict the multiple users in a production environment, FIG. 2 shows multiple clients 230A, 230B, 230C, 230D, 230E and 230F. A user may interact with application instance 212 through one of the clients 230A, 230B, 230C, 230D, 230E and 230F. As pictured, each client is a desktop PC. However, the invention is not limited to use in connection with computer systems in which users access an application through desktop PCs. A client may be implemented with a laptop computer, a portable digital assistant or any other computing device.

FIG. 2 is a schematic illustration of a production environment. Each of the clients 230A, 230B, 230C, 230D, 230E and 230F is shown connected to application instance 212. Such a connection may be made through a network, such as network 160 (FIG. 1). However, the specific mechanism by which each client communicates with an application instance is not a limitation on the invention.

Regardless of the method by which each client 230A, 230B, 230C, 230D, 230E or 230F communicates with instance 212, exchanges between the clients 230A, 230B, 230C, 230D, 230E or 230F may cause instance 212 to access data. As pictured, the data is stored in logical objects 216A and 216B. Logical objects 216A and 216B may be mapped to physical storage locations in a storage system, such as storage system 110 (FIG. 1), as discussed above. Logical objects 216A and 216B, for example, may be data tables in a database or any other type of logical storage object, as the invention is not limited to use with any particular type of logical storage objects.

In production environment 210, an image of the data in each of the logical objects 216A and 216B may be created. The image may be created in response to commands from a network administrator or other user and may be maintained by the storage system as production data is written to the storage system. As one example, the image objects may be stored on one or more BCVs, as discussed above. Regardless of how the image is created, image object 218A contains a copy of the data in logical object 216A and image object 218B contains a copy of the data in logical object 216B.

In operation of a computer system containing production environment 212, it may be desirable to create a replica of the application. Such a replica may be created by storing information that enables recreation of the environment in which the application instance operates.

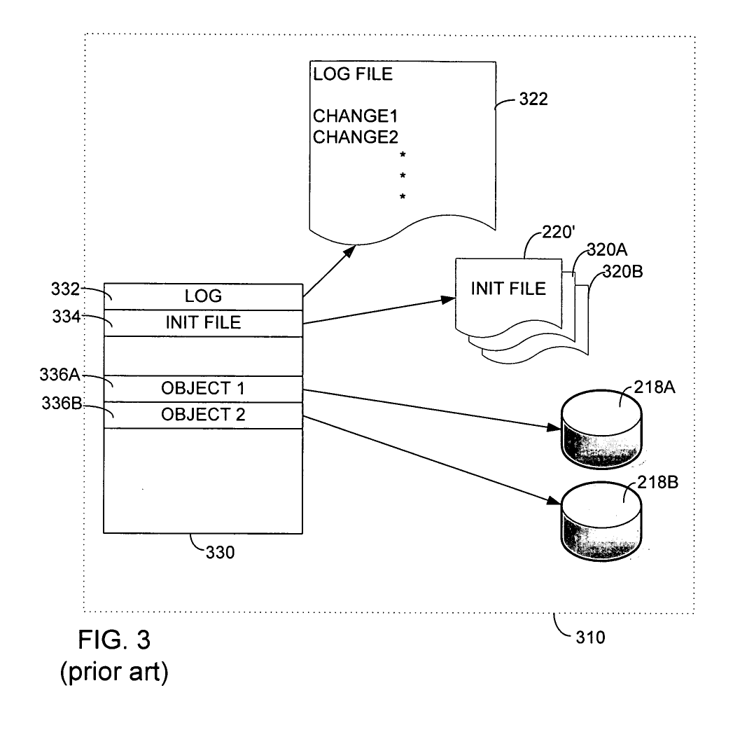

The invention may be used in conjunction with a replica in a format as is known in the art. However, the specific format in which the replica is stored is not a limitation n the invention, as the invention may be used with a replica in any suitable form. As one example, FIG. 3 illustrates a replica 310 that may be created in production environment 210 and stored in a format as known in the art. Replica 310 may be stored in any suitable computer-readable medium, with any suitable data organization. For example, replica 310 may be stored in solid database 132 (FIG. 1). Regardless of where and how stored, replica 310 contains information that can be used to duplicate an instance of the application program that created the production data.

In the embodiment illustrated, replica 310 includes a catalog 330. Catalog 330 is a data structure that has entries identifying the components of the replica. Such a data structure may be implemented in a file or in any other suitable way and in any suitable format.

Entries 336A and 336B identify logical objects containing data included in the image of the production data. In the embodiment illustrated, catalog 330 includes two objects, shown as image components 218A and 218B. Two logical objects are shown for simplicity, but any number of logical objects may be included in catalog 330.

Entry 334 identifies parameters of the production instance of the application that manipulated the production data. In the embodiment of FIG. 3, the parameters are stored in a file. As shown, that file is a copy 220′ of the INIT file 220 (FIG. 2). If parameters of an application instance are stored in formats other than a file, the replica may likewise contain a copy of those other formats. The copy of the parameters may be stored in the same format that those parameters are used to establish a production instance, but the invention is not limited in that respect, as that the replica could include the parameters in a different form from which they are used in the production environment.

The replica may include other files containing parameters or other information required to establish an environment in which the data in the image may be accessed. Accordingly, FIG. 3 shows files 320A and 320B may be included in replica 310 to hold such information. When such files are included, catalog 330 may include corresponding entries to identify those files.

Additionally, catalog 330 may contain entry 332 identifying a log. During the process of creating an image of a database separate from the production data, the production application instance may execute transactions affecting the production data that are not reflected in the image. The application may keep a log of these transactions. In the embodiment illustrated, the log is implemented as log file 332 (which may be stored in solid database 132 or in any other suitable location), although it can be implemented in other ways.

FIG. 3 depicts just one example of the items that may form a replica, as different or additional items may be included in a replica.

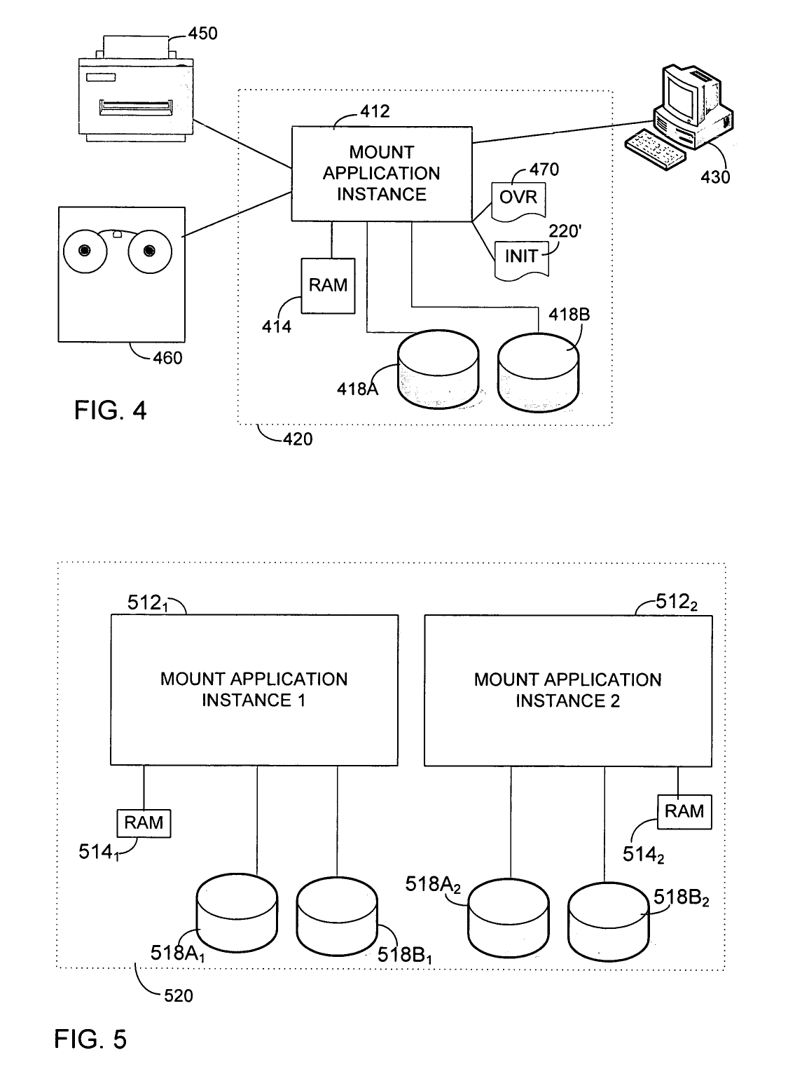

Regardless of the specific construction of the replica, the replica may be used to establish a mount environment 420 as illustrated in FIG. 4. Mount environment 420 includes mount application instance 412 through which data that is part of a replica may be accessed. In the illustrated embodiment, mount application instance 412 is a separate instance of the same application program that created the production data and is used to access the image objects 418A and 418B, which are images of the logical objects of data created from production data.

Once created, mount environment 420 may allow operations on image objects 418A and 418B for any desired purpose. As shown in FIG. 4, a user may interact with mount application instance 412 through a client 430. Here, client 430 is illustrated as a desktop PC, which may be connected to mount host 150 (FIG. 1) over network 160 (FIG. 1). While a desktop PC may act as a client, the nature of the client used to interact with mount application instance 412 is not a limitation on the invention and any suitable device may be used. Also, while a single client is depicted in FIG. 4, the number of clients in the mount environment is not a limitation on the invention.

Mount environment 420 may be created on any suitable computer or computers. In the computer system of FIG. 1, mount environment 420 may be created on mount host 150. However, this embodiment is for illustration only, as it is not necessary that the mount environment be created on a device that is connected to the same local area network as the storage system 110 or production host 120.

Once mount environment 420 is created, a user may interact with mount application instance 412 in much the same way that a user would interact with production application instance 212 to perform operations on a database. However, because the operations are performed on a copy of the production data, the interactions typically involve primarily operations that read data from the database.

Any desired operations may be performed in mount environment 420. For example, mount application instance 412 may access image objects 418A and 418B to generate reports on an output device, such as a printer 450, and/or to make a backup copy of the database on a storage device with removable media, such as tape drive 460. These are examples of operations that may be desirable to perform in a computer system operating a database and can be performed on a copy of a database. By performing these operations in mount environment 420, they do not interfere with or slow operation of production application instance 212 (FIG. 2).

As part of the initialization of mount application instance 412, resources may be allocated to that instance. As show, in the example of FIG. 4, initialization file 220′ is available for initialization of mount application instance 412. As with initialization file 220 (FIG. 2), initialization file 220′ stores values of parameters used to control allocation of resources to an instance of the application program as it is initialized. Initialization file 220′ also may contain values of parameters that control other operating characteristics of the instance. Parameters that enable or disable certain features or functionality of an application are referred to herein as “application switches” and initialization file 220′ may contain values that set one or more application switches.

The values in initialization file 220′ may be obtained in any suitable way. In this example, initialization file 220′ is a copy of initialization file 220 (FIG. 2) stored as part of replica 310 (FIG. 3).

Conventionally, a copy of the initialization file used to create a production instance is used to configure the instance of the application when mounting the replica. Using a copy of the initialization file from the production instance allows creation of a duplicate environment in an automated way. Duplicating the production environment reduces the chances that operations performed in the mount environment will produce different results than if performed in the production environment.

Applicants have appreciated that it is not always desirable for mount environment 420 to be a duplicate of production environment 210 (FIG. 2). Fewer users may access mount application instance 412 than access production application instance 212 (FIG. 2). Also, operations performed in a mount environment may not be as time critical as those performed in the production environment. For example, a user may tolerate a delay of hours in producing a report. Likewise, if a backup of a database is to be created once a day, a user may tolerate a delay of a full day while the computer system creates a backup copy on removable storage media. In contrast, such delays often cannot be tolerated in a production environment.

To ensure that an application performs quickly and accurately in a production environment, the production environment is often configured with a large amount of resources allocated to the production instance. These resources, for example, may include computer memory, number of processes that may be generated by the application, or number of CPU cycles that are available for the application instance, etc. Accordingly, production host 120 (FIG. 1) likely includes a large amount of resources.

Applicants have appreciated that it may not be desirable to require the mount host 150 (FIG. 1) to contain the same amount of resources as production host 120 (FIG. 1). Further, even if mount host 150 (FIG. 1) has the same amount of resources as production host 150 (FIG. 1), it may not be desirable to allocate the same amount of resources to the mount instance that are allocated to the production instance. For example, a user may desire to mount multiple replicas of the same or different databases simultaneously on the same mount host. Simultaneous mounting of multiple replicas may not be possible if each instance must be allocated the amount of resources required for their production counterparts, as the aggregate usage of one or more resources may exceed the total amount of resources on mount host 150.

Accordingly, one embodiment of the invention provides a mechanism to control the amount of resources allocated for a mount application instance. Such a mechanism can be used to configure the mount application instance to consume less of one or more resources than the production application instance on which it is based. In some embodiments, control over these parameters is integrated into the computer system in a way that allows automated mounting of a replica, although all embodiments are not limited in this respect.

In the embodiment of FIG. 4, parameters stored in an override file 470 may be used to control, in whole or in part, the resources allocated to mount application instance 412 such that values in override file 470 may override the values for the corresponding parameters in the initialization file 220′, thereby altering those values from the production environment.

Override file 470 may contain values for only a subset of the parameters controlling initialization of mount application instance 412, or for all of the parameters. As the initialization parameters are used in the initialization process, if a value of a parameter is specified in override file 470, that value is used. If no value for a parameter is specified in override file 470, the value for the parameter in the copy 220′ of the initialization file used in the production environment is used. Accordingly, initialization file 220′ and override file 470 combine to specify values of parameters that control characteristics of mount application instance 412. Regardless of the source of the value for a parameter, mount application instance 412 thereafter may be created using that value of a parameter.

Override file 470 may be created in any suitable way. For example, a system administrator or other user may specify values of certain parameters and store them in override file 470.

Different or additional ways may be used to specify values of parameters that control characteristics of mount application instance 412 or otherwise specify characteristics of mount environment 420. For example, the override values need not be stored in a file. A user may enter override values through a user interface on client 430, and such values could be stored in RAM or other suitable computer-readable medium in any suitable form until used for initialization of mount application instance 412.

Further, the override parameters need not be stored separately from initialization file 220′. Override values could be stored by directly changing the values for one or more parameters in the initialization file 220′. Such a change could be made manually, such as by a user opening an editing program on client 430 and altering the values stored in initialization file 220′. Alternatively, the process could be performed under control of a computer-executable program that receives override values specified by a user and automatically alters the values stored in initialization file 220′. It should be appreciated that changes to the initialization parameters stored in initialization file 220′ need not be made within the same file structure, as a new file can be created by copying values of some parameters from initialization file 220′ and incorporating some override values.

As should be appreciated from the foregoing, the override values can be consolidated with values from the production environment in any suitable way, as the invention is not limited to any particular technique. Regardless of how the override values of the parameters are specified, once initialized with these values, mount application instance 412 may be used in any desired manner.

As discussed above, in one embodiment, the resources are controlled to enable mounting multiple replicas on the same mount host. FIG. 5 shows multiple replicas mounted on the same mount host 520. In the embodiment of FIG. 5, application instance 512₁ and application instance 512₂ execute on mount host 520. Application instance 512₁ interacts with image objects 518A₁ and 518B₁. Application instance 512₂ interacts with image objects 518A₂ and 518B₂. Image objects 518A₁ and 518B₁ may be a portion of a replica of a first database and image objects 518A₂ and 518B₂ may be a portion of a replica of a second database. Allocating a smaller amount of resources to each application instance than its production counterpart can facilitate mounting multiple replicas on mount host 520 simultaneously. In the embodiment illustrated in FIG. 5, smaller amounts of RAM 514₁ and RAM 514₂ are allocated to application instances 512₁ and application instance 512₂, respectively, than to their production counterparts.

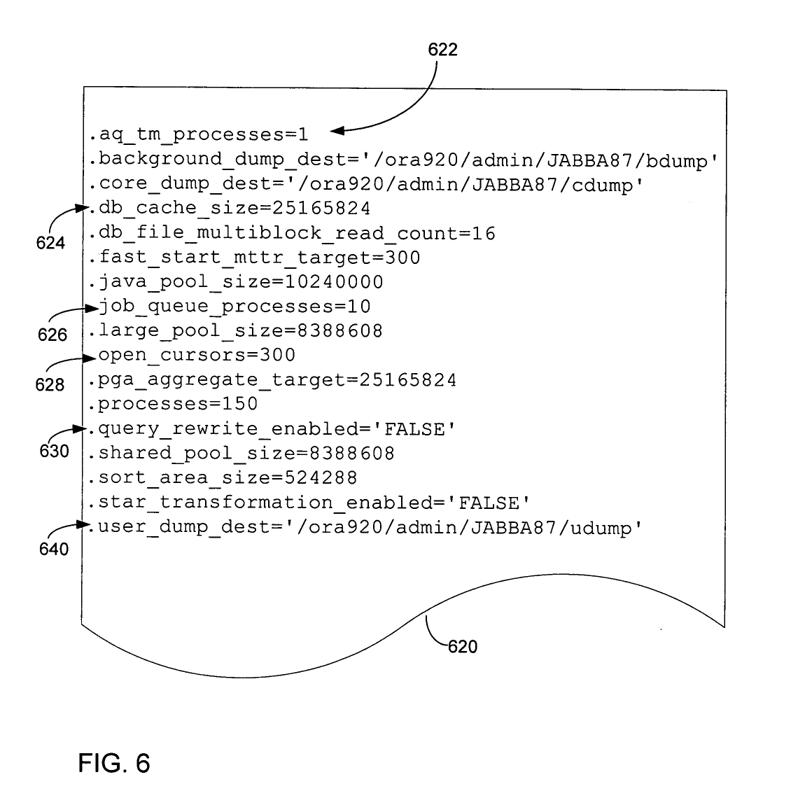

As mentioned above, memory is not the only type of resource whose allocation may be modified for the mount environment to differ from the production environment, as aspects of the invention can be used for any resource allocated to an instance of a mount application. Further, allocation of resources is not the only characteristic of a mount environment that can be controlled to differ from the production environment when creating a mount environment. FIG. 6 provides an example of parameters and values that may be specified as part of override file 470 (FIG. 4), or otherwise, to alter the mount environment from the production environment.

FIG. 6 shows an embodiment of an override file 620. In the pictured embodiment, multiple parameters for which override values can be specified are shown. The parameters of FIG. 6 serve as an example only and different or additional parameters may be controlled. Further, in mounting a replica, values may be specified for only a portion of the parameters that can be controlled In the example of FIG. 6, a consistent syntax is used to specify override values for parameters. Each line contains a command that specifies an override value for one parameter. On each line, an identifier of the parameter appears first. Following an “=” sign, the override value of the parameter is specified.

The syntax of FIG. 6 is for illustration only. Values for parameters could be specified in an XML file or any other suitable syntax.

The parameters indicated in FIG. 6 represent parameters that are appropriate for use with an ORACLE® database. The specific parameters for which override values may be specified and an appropriate range of values for each parameter will depend on the specific application program from which an application instance is to be created.

In this example, some of the parameters control resource usage. For example, line 624 sets the value of a parameter used to set the size of a database cache. Setting a database cache size is one way that memory within the mount host is allocated to the mount application instance. Other types of resources may also be allocated based on values in override file 620. For example, line 622 sets a value of a parameter “aq_tm_processes” and line 626 sets a value of a parameter “job_queue_processes.” Each of these lines sets a limit on the number of processes that may exist simultaneously. Limiting processes is one way that processor resources may be allocated. Similarly, line 628 sets a value for a parameter “open_cursors.” Limiting the number of open cursors is yet another way that resources may be allocated to an instance of an application program.

Not all of the characteristics set in override value file 620 allocate resources. Any operating characteristic that can be controlled may be set with an override value specified in override file 620. For example, line 630 sets an operating switch associated with the application program. More specifically, line 630 sets a parameter “query_rewrite_enabled” to false. The instance of the application program created with such a parameter setting is configured to prevent queries from being rewritten. As another example, line 640 sets a value of a parameter indicating the location at which certain output is to be stored.

Thus, the use of an override file such as override file 620 allows multiple parameters of different types to be selectively set upon the creation of an application instance. In one embodiment, if no value for a parameter is included in override file 620, a mount environment is established with that parameter having the same value that it had in the production environment. In other embodiments, parameters whose values are not overridden may be set to a default value or set in any other suitable way.

The parameters depicted in FIG. 6 correspond to operating parameters conventionally set in an initialization file associated with an ORACLE® database. The inventors have observed that the parameters listed, if given override values, do not interfere with the operation of the replica of a database, even if the override values differ from those in a production environment. In one embodiment, the parameters listed may be the only parameters for which override values are specified, and a computer system mounting a replica may be programmed to ignore an attempt to alter any parameter other than those listed to ensure that a user cannot unintentionally modify a parameter in a way that may interfere with proper execution of the mount instance. However, it should be appreciated that this feature is optional, and that other embodiments need not be limited to a predefined set of parameters.

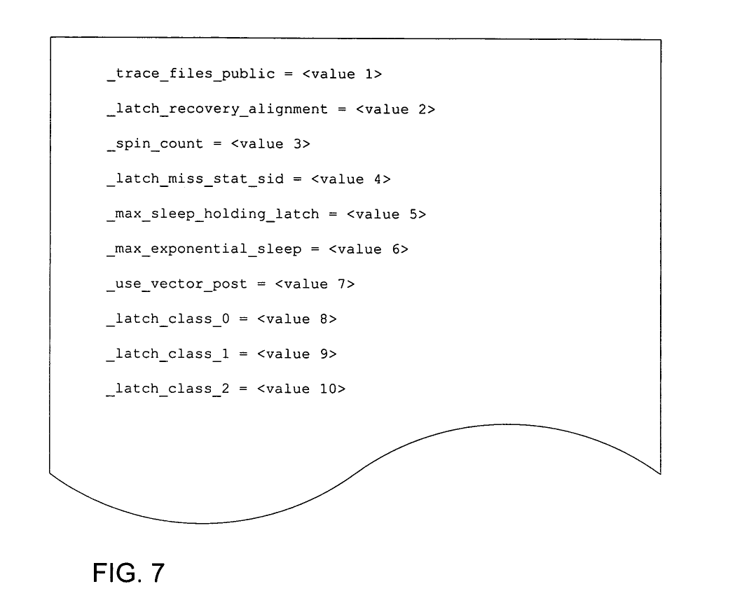

FIG. 7 illustrates another embodiment of an override file 720. In the embodiment of FIG. 7, override file 720 contains parameters that are not traditionally set as part of the initialization of an application instance. The parameters listed are undocumented parameters that may be set at the direction of customer service personnel representing the supplier of the application program. Such undocumented codes are frequently included in complex software programs as an aid for problem identification and resolution.

In this embodiment, override file 720 follows the syntax of the override file 620, though such syntax is not required. Each line includes an identification of a parameter and a value assigned to that parameter.

Because, in most instances, the undocumented parameters identified in override file 720 will not be expressly set when initializing a production instance, the values set in override file 720 will override whatever default values exist for these parameters if no value is set in the production environment. Nonetheless, the override mechanism used when mounting a replica may be used to appropriately configure the mount application instance.

The number and types of parameters that may be set as part of the parameter override process depends on the specific application program in use. Table I lists a set of undocumented parameters for an ORACLE® database, but different or additional parameters may be set for other application programs.

TABLE I

| | |
|---|---|
| _trace_files_public | _disable_kcbhxor_osd |
| _latch_recovery_alignment | _disable_system_state |
| _spin_count | _single_process |
| _latch_miss_stat_sid | _cpu_count |
| _max_sleep_holding_latch | _number_cached_attributes |
| _max_exponential_sleep | _watchpoint_on |
| _use_vector_post | _ksdxw_num_sgw |
| _latch_class_0 | _ksdxw_num_pgw |
| _latch_class_1 | _ksdxw_stack_depth |
| _latch_class_2 | _ksdxw_cini_flg |
| _latch_class_3 | _ksdxw_nbufs |
| _latch_class_4 | _enable_kgh_policy |
| _latch_class_5 | _NUMA_pool_size |
| _latch_class_6 | _enable_NUMA_optimization |
| _latch_class_7 | _shared_pool_reserved_pct |
| _latch_classes | _shared_pool_reserved_min_alloc |
| _session_idle_bit_latches | _large_pool_min_alloc |
| _ksu_diag_kill_time | _use_ism |
| _num_longop_child_latches | _lock_sga_areas |
| _test_ksusigskip | _NUMA_instance_mapping |
| _kghdsidx_count | _lm_activate_lms_threshold |
| _realfree_heap_max_size | _lm_lmd_waittime |
| _realfree_heap_free_threshold | _lm_lms_waittime |
| _realfree_heap_mode | _lm_procs |
| _use_realfree_heap | _lm_ress |
| _test_param_1 | _lm_locks |
| _test_param_2 | _lm_master_weight |
| _test_param_3 | _active_standby_fast_reconfiguration |
| _test_param_4 | _lm_enq_rcfg |
| _test_param_5 | _lm_dynamic_remastering |
| _test_param_6 | _lm_xids |
| _instance_type | _lm_res_part |
| _dbg_proc_startup | _lm_drm_window |
| _messages | _lm_num_pcmhv_latches |
| _enqueue_locks | _lm_node_join_opt |
| _enqueue_hash | _lm_non_fault_tolerant |
| _enqueue_debug_multi_instance | _lm_cache_res_cleanup |
| _enqueue_hash_chain_latches | _lm_cache_res_type |
| _ksi_trace | _lm_cache_lvl0_cleanup |
| _trace_processes | _lm_send_buffers |
| _trace_archive | _lm_rcv_buffer_size |
| _trace_events | _lm_direct_sends |
| _trace_buffers | _ogms_home |
| _trace_flush_processes | _lm_sync_timeout |
| _trace_file_size | _lm_ticket_active_sendback |
| _trace_options | _lm_rcfg_timeout |
| _nchar_imp_cnv | _lm_enq_lock_freelist |
| _disable_file_locks | _lm_enqeue_freelist |
| _disable_odm | _lm_dd_interval |
| _open_files_limit | _dlmtrace |
| _enable_list_io | _lm_tx_delta |
| _db_file_direct_io_count | _lm_proc_freeze_timeout |
| _ioslave_issue_count | _lm_validate_resource_type |
| _ioslave_batch_count | _lm_file_affinity |
| _io_slaves_disabled | _lm_share_lock_opt |
| _lgwr_io_slaves | _lm_res_hash_bucket |
| _arch_io_slaves | _lm_msg_batch_size |
| _backup_disk_io_slaves | _lm_tickets |
| _backup_io_pool_size | _lm_msg_cache_thresholds |
| _high_server_threshold | _lm_msg_cleanup_interval |
| _low_server_threshold | _lm_send_queue_length |
| _yield_check_interval | _lm_send_queue_batching |
| _first_spare_parameter | _lm_process_batching |
| _second_spare_parameter | _lm_sq_batch_factor |
| _third_spare_parameter | _abort_recovery_on_join |
| _fourth_spare_parameter | _send_ast_to_foreground |
| _fifth_spare_parameter | _send_close_with_block |
| _sixth_spare_parameter | _gcs_fast_reconfig |
| _seventh_spare_parameter | _cr_grant_global_role |
| _ksmg_granule_size | _cr_grant_local_role |
| _ksmg_granule_locking_status | _reliable_block_sends |
| _object_statistics | _skip_assume_msg |
| _diag_daemon | _gcs_resources |
| _dump_system_state_scope | _gcs_latches |
| _lm_lms | _pcm_shadow_locks |
| _lm_dynamic_lms | _side_channel_batch_size |
| _lm_max_lms | _side_channel_batch_timeout |
| _lm_min_lms | _trace_pin_time |
| _recovery_claim_batch_size | _db_cache_advice_sample_factor |
| _master_direct_sends | _db_cache_advice_batch_size |
| _cgs_send_timeout | _db_mttr_advice |
| _imr_active | _db_mttr_sim_target |
| _imr_max_reconfig_delay | _db_mttr_sample_factor |
| _imr_splitbrain_res_wait | _db_mttr_partitions |
| _lm_dynamic_load | _db_mttr_sim_trace_size |
| _scn_scheme | _db_mttr_trace_to_alert |
| _disable_latch_free_SCN_writes_via_32cas | _minimum_giga_scn |
| _disable_latch_free_SCN_writes_via_64cas | _compatible_no_recovery |
| _controlfile_enqueue_timeout | _db_block_check_for debug |
| _db_block_buffers | _db_always_check_system_ts |
| _db_block_cache_protect | _log_checkpoint_recovery_check |
| _dbwr_tracing | _two_pass |
| _disable_multiple_block_sizes | _log_archive_buffers |
| _small_table_threshold | _log_archive_buffer_size |
| _db_block_cache_num_umap | _log_archive_callout |
| _db_block_lru_latches | _log_archive_net_timeout |
| _db_block_granule_interval | _log_archive_delta_sync_wait |
| _db_block_max_scan_pct | _lgwr_max_ns_wt |
| _db_writer_scan_depth_pct | _ns_max_flush_wt |
| _db_large_dirty_queue | _lgwr_ns_sim_err |
| _db_writer_max_writes | _lgwr_ns_nl_min |
| _db_writer_chunk_writes | _lgwr_ns_nl_max |
| _db_block_med_priority_batch_size | _lgwr_async_io |
| _db_block_hi_priority_batch_size | _lgwr_delay_write |
| _db_writer_histogram_statistics | _log_io_size |
| _dbwr_async_io | _log_switch_timeout |
| _dbwr_scan_interval | _log_buffers_debug |
| _db_block_prefetch_quota | _log_buffers_corrupt |
| _db_block_max_dirty_target | _log_debug_multi_instance |
| _db_block_numa | _log_simultaneous_copies |
| _db_percent_hot_default | _disable_logging |
| _db_percent_hot_keep | _db_file_noncontig_mblock_read_count |
| _db_percent_hot_recycle | _omf |
| _db_aging_hot_criteria | _hard_protection |
| _db_aging_stay_count | _allow_error_simulation |
| _db_aging_cool_count | _kcl_use_cr |
| _db_aging_touch_time | _kcl_local_file_time |
| _db_aging_freeze_cr | _recovery_asserts |
| _db_block_hash_buckets | _gc_integrity_checks |
| _db_block_hash_latches | _keep_recovery_buffers |
| _db_handles | _gc_defer_time |
| _db_handles_cached | _gc_latches |
| _wait_for_sync | _kcl_debug |
| _db_block_cache_clone | _kcl_index_split |
| _db_block_trace_protect | _kcl_commit |
| _db_block_max_cr_dba | _fairness_threshold |
| _trace_buffer_flushes | _interconnect_checksum |
| _trace_multi_block_reads | _defer_multiple_waiters |
| _trace_cr_buffer_creates | _cr_server_log_flush |
| _write_clones | _ping_level |
| _trace_buffer_gets | _kcl_name_table_latches |
| _check_block_after_checksum | _async_recovery_reads |
| _recovery_percentage | _async_recovery_claims |
| _bwr_for_flushed_pi | _avoid_prepare |
| _send_requests_to_PI | _passwordfile_enqueue_timeout |
| _kcl_undo_locks | _dynamic_rls_policies |
| _kcl_undo_grouping | _app_ctx_vers |
| _kcl_recovery_read_batch | _distributed_recovery_connection_hold_time |
| _kcl_conservative_log_flush | _pmon_load_constants |
| _adaptive_direct_read | _dispatcher_rate_ttl |
| _disable_incremental_checkpoints | _dispatcher_rate_scale |
| _dump_MTTR_to_trace | _plsql_dump_buffer_events |
| _log_blocks_during_backup | _job_queue_interval |
| _allow_resetlogs_corruption | _optimizer_percent_parallel |
| _allow_terminal_recovery_corruption | _optimizer_search_limit |
| _allow_read_only_corruption | _parallel_default_max_instances |
| _tts_allow_nchar_mismatch | _system_trig_enabled |
| _disable_recoverable_recovery | _kkfi_trace |
| _log_committime_block_cleanout | _kolfuseslf |
| _ktc_latches | _px_trace |
| _allocate_creation_order | _parallel_server_idle_time |
| _log_space_errors | _parallel_server_sleep_time |
| _bump_highwater_mark_count | _dynamic_stats_threshold |
| _last_allocation_period | _parallel_fake_class_pct |
| _inst_locking_period | _px_load_publish_interval |
| _allocation_update_interval | _parallel_execution_message_align |
| _ktu_latches | _PX_use_large_pool |
| _rollback_segment_initial | _parallel_min_message_pool |
| _rollback_segment_count | _tq_dump_period |
| _offline_rollback_segments | _affinity_on |
| _corrupted_rollback_segments | _enable_default_affinity |
| _enable_block_level_transaction_recovery | _dss_cache_flush |
| _cleanup_rollback_entries | _hash_multiblock_io_count |
| _smu_error_simulation_site | _cursor_db_buffers_pinned |
| _smu_error_simulation_type | _old_connect_by_enabled |
| _collect_undo_stats | _table_lookup_prefetch_size |
| _smu_debug_mode | _multi_join_key_table_lookup |
| _verify_undo_quota | _table_lookup_prefetch_thresh |
| _discrete_transactions_enabled | _adaptive_fetch_enabled |
| _row_cr | _disable_sun_rsm |
| _smon_internal_errlimit | _ipc_test_failover |
| _smon_consume_post | _ipc_test_mult_nets |
| _transaction_recovery_servers | _ipc_fail_network |
| _parallel_recovery_stopat | _trace_instance_termination |
| _release_insert_threshold | _oracle_trace_events |
| _walk_insert_threshold | _oracle_trace_facility_version |
| _use_seq_process_cache | _no_objects |
| _reuse_index_loop | _domain_index_batch_size |
| _kdbl_enable_post_allocation | _domain_index_dml_batch_size |
| _ignore_desc_in_index | _insert_enable_hwm_brokered |
| _keep_remote_column_size | _all_shared_dblinks |
| _row_cache_cursors | _close_cached_open_cursors |
| _kgl_multi_instance_lock | _init_sql_file |
| _kgl_multi_instance_pin | _sort_multiblock_read_count |
| _kgl_multi_instance_invalidation | _sort_space_for_write_buffers |
| _kgl_latch_count | _shrunk_aggs_enabled |
| _kgl_bucket_count | _shrunk_aggs_disable_threshold |
| _library_cache_advice | _gby_onekey_enabled |
| _kglsim_maxmem_percent | _optimizer_undo_changes |
| _optimizer_mode_force | _sql_connect_capability_table |
| _explain_rewrite_mode | _query_cost_rewrite |
| _query_rewrite_or_error | _query_rewrite_2 |
| _sort_elimination_cost_ratio | _query_rewrite_1 |
| _sql_connect_capability_override | _query_rewrite_fudge |
| _always_anti_join | _query_rewrite_expression |
| _always_star_transformation | _query_rewrite_jgmigrate |
| _b_tree_bitmap_plans | _query_rewrite_fpc |
| _column_elimination_off | _query_rewrite_drj |
| _cpu_to_io | _query_rewrite_maxdisjunct |
| _optimizer_cost_model | _query_rewrite_vop_cleanup |
| _optimizer_undo_cost_change | _full_pwise_join_enabled |
| _optimizer_system_stats_usage | _partial_pwise_join_enabled |
| _new_sort_cost_estimate | _slave_mapping_enabled |
| _complex_view_merging | _slave_mapping_group_size |
| _unnest_subquery | _local_communication_costing_enabled |
| _eliminate_common_subexpr | _local_communication_ratio |
| _pred_move_around | _parallelism_cost_fudge_factor |
| _push_join_predicate | _left_nested_loops_random |
| _push_join_union_view | _improved_row_length_enabled |
| _fast_full_scan_enabled | _px_index_sampling |
| _optim_enhance_nnull_detection | _index_join_enabled |
| _idl_conventional_index_maintenance | _use_nosegment_indexes |
| _enable_cscn_caching | _enable_type_dep_selectivity |
| _parallel_broadcast_enabled | _sqlexec_progression_cost |
| _px_broadcast_fudge_factor | _improved_outerjoin_card |
| _px_kxib_tracing | _optimizer_adjust_for_nulls |
| _px_granule_size | _optimizer_degree |
| _px_async_getgranule | _optimizer_choose_permutation |
| _px_min_granules_per_slave | _use_column_stats_for_function |
| _px_max_granules_per_slave | _subquery_pruning_cost_factor |
| _px_no_stealing | _subquery_pruning_reduction |
| _parallel_adaptive_max_users | _subquery_pruning_enabled |
| _parallel_load_balancing | _subquery_pruning_mv_enabled |
| _parallel_load_bal_unit | _parallel_txn_global |
| _pdml_slaves_diff_part | _or_expand_nvl_predicate |
| _pdml_gim_sampling | _like_with_bind_as_equality |
| _pdml_gim_staggered | _table_scan_cost_plus_one |
| _px_dynamic_opt | _sortmerge_inequality_join_off |
| _px_dynamic_sample_size | _cost_equality_semi_join |
| _predicate_elimination_enabled | _default_non_equality_sel_check |
| _groupby_nopushdown_cut_ratio | _new_initial_join_orders |
| _groupby_orderby_combine | _oneside_colstat_for_equijoins |
| _temp_tran_block_threshold | _column_tracking_level |
| _temp_tran_cache | _optim_peek_user_binds |
| _ordered_semijoin | _mv_refresh_selections |
| _always_semi_join | _cursor_plan_enabled |
| _ordered_nested_loop | _minimal_stats_aggregation |
| _nested_loop_fudge | _mv_refresh_eut |
| _project_view_columns | _mav_refresh_consistent_read |
| _no_or_expansion | _mav_refresh_opt |
| _system_index_caching | _mav_refresh_unionall_tables |
| _serial_direct_read | _mv_refresh_delta_fraction |
| _enable_multitable_sampling | _force_temptables_for_gsets |
| _ncmb_readahead_enabled | _pga_max_size |
| _ncmb_readahead_tracing | _smm_auto_min_io_size |
| _index_prefetch_factor | _smm_auto_max_io_size |
| _smm_control | _smm_auto_cost_enabled |
| _smm_trace | _olap_allocate_errorlog_header |
| _smm_min_size | _olap_allocate_errorlog_format |
| _smm_max_size | _olap_poutlog_echo_to_eventlog |
| _smm_px_max_size | _olap_eif_export_lob_size |
| _smm_bound | |
| _smm_advice_log_size | |
| _smm_advice_enabled | |
| _gs_anti_semi_join_allowed | |
| _mv_refresh_use_stats | |
| _optim_new_default_join_sel | |
| _use_new_explain_plan | |
| _ldr_io_size | |
| _unnest_notexists_sq | |
| _optimizer_dyn_smp_blks | |
| _pre_rewrite_push_pred | |
| _optimizer_new_join_card_computation | |
| _mav_refresh_double_count_prevented | |
| _pct_refresh_double_count_prevented | |
| _mv_refresh_new_setup_disabled | |
| _load_without_compile | |
| _precompute_gid_values | |
| _union_rewrite_for_gs | |
| _nested_mav_fast_oncommit_enabled | |
| _generalized_pruning_enabled | |
| _rowsource_execution_statistics | |
| _bitmap_or_improvement_enabled | |
| _intrapart_pdml_enabled | |
| _optim_adjust_for_part_skews | |
| _force_datefold_trunc | |
| _two_pass_reverse_polish_enabled | |
| _aq_tm_scanlimit | |
| _olap_continuous_trace_file | |
| _olap_parallel_update_threshold | |
| _olap_aggregate_buffer_size | |
| _olap_aggregate_min_buffer_size | |
| _olap_aggregate_child_fragment_size | |
| _olap_aggregate_child_max_size | |
| _olap_aggregate_work_per_thread | |
| _olap_aggregate_min_thread_status | |
| _olap_aggregate_statlen_thresh | |
| _olap_aggregate_worklist_max | |
| _olap_aggregate_max_thread_tuples | |
| _olap_aggregate_store_probability | |
| _olap_aggregate_function_merge_threshold | |
| _olap_aggregate_function_cache_enabled | |
| _olap_dimsave_restore_cache_values | |

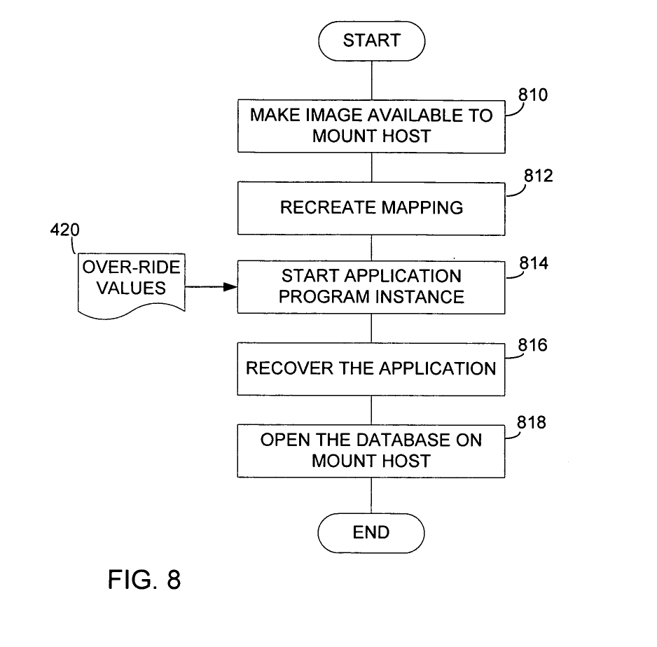

FIG. 8 is a flowchart of a process for mounting a replica in accordance with one embodiment. The processing illustrated in FIG. 8 may be performed under control of replication management software executing on a replication server 130 (or on any other suitable device) in response to a user command or in any other suitable way.

The process of FIG. 8 begins at block 810, wherein the image objects that are part of the replica are made visible to software on the mount host. The processing at block 810 may be performed in any suitable way. In an embodiment in which replication management software includes a replication agent resident on a mount host that is adapted to interact with an application program, making the image available to the mount host may involve sending to the agent an identification of the logical volumes within storage system 110 that contain the objects in the replica. Such an indication may be obtained from catalog 330 or in any other suitable way.

The process then proceeds to block 812, wherein a mapping for accessing image 15 objects is recreated. As described above, a computer system including an application interfacing with a storage system may include one or more mapping layers that maps logical identifiers used in an application to logical volumes in the storage system. To access a replica of a database, a comparable mapping is mounted so that, as a mount application instance executes on the mount server, it can use the same mapping as used in the production instance to access data in the image. If there are multiple mapping layers, the processing at block 812 may be performed in steps, with each step recreating a successively higher layer of the mapping. Processing at block 812 performs the processing to recreate the mapping in any suitable way.

At block 814, a mount application instance is initialized. As described above, override file 470 may be provided and contain values for one or more parameters. In the illustrated embodiment, the mount application instance uses parameter values that are the same as the values used for the production instance, unless overridden. Any suitable approach may be used for overriding parameter values. In one embodiment, a replication management agent may invoke an application program, which creates an instance of that application program as the mount application instance. That instance may be initialized based on one or more parameter files identified when the application is invoked. In some embodiments, the replication management agent may construct a parameter file representing a combination of the parameters in an initialization file 220′ (FIG. 2) and override values in override file 470 (FIG. 4). The replication management agent may provide this file as the file containing the initialization values for the mount application program instance. However, any suitable approach for initializing an application instance may be used, as the invention is not limited to any particular implementation technique.

The process proceeds to block 816. At block 816, the application is recovered. In embodiments in which the replica includes a log of changes to the production data that should be part of the image but are not reflected in image objects in storage system 110, recovering the application may include adjusting the data in the image objects to reflect changes captured in the log. In the pictured embodiment, processing at block 816 may be performed in the same manner used when mounting a replica with values that have not been overridden, but any suitable processing techniques may be used.

Once a mount instance is created and is associated with the image objects of the replica, processing proceeds to block 818. At block 818, the database may be opened, meaning that clients connected to the mount host may access the data in the database. Opening the mount database may be performed as in any suitable way.

It should be appreciated that some or all of the steps depicted in FIG. 8 may be omitted. For example, it may be desirable in some embodiments to allow a user to manually open the database. In such embodiments, processing in block 818 may be omitted.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments of the present invention comprises at least one computer-readable medium (e.g., a computer memory, a floppy disk, a compact disk, a tape, etc.) encoded with a computer program (i.e., a plurality of instructions), which, when executed on a processor, performs the above-discussed functions of the embodiments of the present invention.

The computer-readable medium can be transportable such that the program stored thereon can be loaded onto any computer environment resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

It should be appreciated that in accordance with several embodiments of the present invention wherein processes are implemented in a computer readable medium, the computer implemented processes may, during the course of their execution, receive input manually (e.g., from a user).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method for use with a computer system, the computer system comprising a first instance of a database operating in a first environment, the first instance having allocated thereto a first amount of a resource, the method comprising:
creating a replica of the first instance of the database; and
establishing from the replica a second instance of the database in a second environment, the second instance having allocated thereto a second amount of the resource, the second amount of the resource being different from the first amount of the resource.

2. The method of claim 1, wherein the database has a parameter that specifies allocation of the resource, the parameter having a first value for the first instance; and
wherein establishing the second instance comprises establishing the second instance with the parameter having a second value, different from the first value.

3. The method of claim 2, wherein the replica includes the first value of the parameter; and
the method further comprises modifying the replica to replace the first value with the second value.

4. The method of claim 3, wherein establishing the second instance of the database comprises mounting the modified replica in the second environment.

5. The method of claim 2, wherein the database has a second parameter having a third value in the first instance and wherein establishing the second instance comprises establishing the second instance with the same third value of the second parameter.

6. The method of claim 2, wherein the first instance of the database comprises an instance of a database application, and wherein the first parameter specifies the amount of memory allocated to the instance of the database application.

7. The method of claim 6, wherein the instance of the database application is a first instance of a database application and the second instance of the database has a second instance of the database application, and the method further comprises:
operating the first instance of the database in the first environment on a first device with a first amount of memory allocated to the first instance of the database application; and
operating the second instance of the database in the second environment on a second device with a second amount of memory allocated to the second instance of the database application.

8. The method of claim 1, wherein the first instance of the database is on a first device and the second instance of the database is established on a second device, the method further comprising, on the second device:
establishing from a second replica an instance of a second database; and
operating the second instance of the database and the instance of the second database concurrently.

9. The method of claim 8, wherein operating the second instance of the database and the instance of the second database comprises running a report on each of the second instance and the instance of the second database.

10. A method for use with a computer system, the computer system comprising a first instance of a database operating in a first environment, the first instance having allocated thereto a first amount of a resource, the method comprising:
establishing a second instance of the database in a second environment based on a replica of the first instance, the replica having a first value of a parameter specifying the first amount of the resource, the second instance having a second value of the parameter so that a second amount of the resource, different from the first amount, is allocated to the second instance.

11. The method of claim 10, wherein the first instance is associated with a first initialization file, the first initialization file comprising the value of the parameter specifying the first amount of the resource; and
wherein establishing the second instance comprises mounting the replica in a second environment using a second initialization file, the second initialization file comprising the second value of the parameter.

12. The method of claim 11, further comprising creating the second initialization file by editing the first initialization file.

13. The method of claim 11, further comprising creating the second initialization file by selectively combing values from the first initialization file and override values.

14. At least one computer-readable medium for use with a computer system comprising a first instance of a database operating in a first environment, the first instance having allocated thereto a first amount of a resource, the at least one computer-readable medium having stored thereon computer-executable instructions for:
creating a replica of the first instance of the database; and
establishing from the replica a second instance of the database in a second environment, the second instance having allocated thereto a second amount of the resource, the second amount of the resource being different from the first amount of the resource.

15. The at least one computer-readable medium of claim 14, wherein the first instance of the database comprises a first instance of a database application and database data, and the replica comprises:
a first data structure stored on the at least one computer-readable media, the first data structure comprising a plurality of fields, each field for storing an identification of a component containing an image of a portion of the database data in the first instance of the database;
a second data structure stored on the at least one computer-readable media, the second data structure comprising a plurality of fields, each field for storing a value of a parameter associated with a first instance of the database application, the first instance of the database application being associated with the first instance of the database, wherein at least one field of the plurality of fields of the second data structure holds a value of a resource parameter indicating an amount of a resource used by the first instance of the database application.

16. The at least one computer-readable medium of claim 15, wherein the first data structure is a catalog for a replica of the database.

17. The computer-readable medium of claim 16, wherein the second data structure is a copy of an initialization file used to create the first instance of the database application.

18. The at least one computer-readable medium of claim 14, wherein the computer-executable instructions for establishing a second instance is a portion of an application program for automating mounting of database replicas.

19. The at least one computer-readable medium of claim 15, wherein the computer-executable instructions for establishing a second instance of the database comprise computer-executable instructions for:
establishing the second instance with a second instance of the database application configured to operate according to values of parameters stored in a portion of the plurality of fields in the second data structure and a value of the resource parameter different than the value stored in the second data structure; and
configuring the second instance to access components of the database image identified in the first data structure.

20. The at least one computer-readable medium of claim 14, further having stored thereon computer-executable instructions for making a backup copy of the first instance of the database from the second instance of the database.
